(19) United States
(12) Patent Application Publication
(10) Pub. No.: US 2024/0160424 A1
(43) Pub. Date: May 16, 2024

(54) SYSTEM, DEVICES AND METHODS FOR PROVISION AND INSTALLATION OF CONTENT RELATED TO PRODUCT

(71) Applicant: Telefonaktiebolaget LM Ericsson (PUBL), Stockholm (SE)

(72) Inventor: Andreas Kristensson, SÖDRA SANDBY (SE)

(21) Appl. No.: 18/550,320

(22) PCT Filed: Mar. 17, 2021
(86) PCT No.: PCT/EP2021/056793

§ 371 Date: Sep. 13, 2023

(51) Int. Cl. G06F 8/61

(52) U.S. Cl. CPC G06F 8/61

(57) ABSTRACT

System, devices and methods are provided for simplify provisioning and installation of a content related to a product to a user device associated with a receiver of the product. The embodiments herein enable right timing for provisioning of the content triggered by an electronic label attached to a package of the product. All related contents or applications is available for installation on the user device just as the purchaser opens the package. There is no need for the user to search for what applications to install.

### TECHNICAL FIELD

Embodiments herein relate to system, devices and methods for provision and installation of a content related to a product. In particular, the embodiments relate to easy and automatical provisioning and installing of contents, applications or media related to consumer devices to a user device.

### BACKGROUND

Today's consumer devices or products such as headsets and similar devices that need to connect to a user device, e.g., a user equipment (UE), a mobile device or a smartphone, often require special applications being installed on said user device so as to get full access to the consumer devices' functionality.

One example is a Jabra Evolve2 65 Bluetooth headset, where Jabra offers smartphone applications that will let a user make the most out of their headset. The user will have to read the manual and/or the print on the headset package and/or search the Internet or Jabra.com for directions on where to find the correct application and how to download and install it. This is a time consuming and tedious procedure, especially when a consumer device has complicated and advanced functionalities, which may lead to an unpleasant experience and frustrations for the user from the new purchased consumer device instead of a joyful experience.

Continuous developments of Internet of Things (IoTs) and smart devices will affect all industries and ultimately everyone's daily life. A market that is taking off for smart home devices e.g., smart locks, security cameras, video doorbells, smart thermostats etc., smart household appliances e.g., smart TV, dishwashers, refrigerators, vacuum cleaners, washing machines, air purifiers etc., as well as smart wearable devices e.g., smart watches, fitness trackers, smart belts, smart shoes etc., that will revolutionize the way of living and working.

Wireless technologies will enable connectivity of all these IoTs elements. IoTs applications requiring global coverage and mobility will focus on cellular technologies, such as the 4^{th} generation (4G) based Long Term Evolution Machine Type Communication (LTE-M) and Narrow Band IoT (NB-IoT) technologies and 5G in the future. Others will rely on low-power Wide Area Network (WAN) technologies operating in the unlicensed bands, such as Sigfox or LoRaWAN. The majority will use short-range or midrange wireless technologies such as Bluetooth®, Wireless Local Area Network (WLAN/Wi-Fi), Zigbee, Thread and others.

Connecting everything in homes and buildings will bring amazing user experiences to life and provide a safe and convenient living and working environment. However, the procedure for setting up the applications and connections of the IoTs seems still to be quite immature from a user experience perspective, since there is often a hassle for each set up and it is difficult to make them all work together.

Therefore, there is a need to simplify the setup procedure for applications and connections of the consumer products.

US20150302417A1 provides methods for providing a personalized customer service experience using a customer service application. A sensor associated with a container configured to house one or more devices can determine whether the container has been opened. A processor can access a profile associated with the container and the devices that includes at least a first value uniquely identifying the container. The processor can activate a communication module to send a first message via a communication network to a backend system. The first message can include some of the accessed profile. The first message can prompt the backend system to search for a customer record using the first value and to send a second message to a mobile device that prompts execution of an application on the mobile device.

US20200051015A1 discloses a shipping package tracking or monitoring system. The shipping package comprising an enclosure for receiving content, a closure for sealing the enclosure, a network module, a sensor module, and a battery module. A label comprising shipping information can be included with the shipping package. The shipping package is monitored during travelling between a source and a destination by the sensor module. The sensor module provides location information to the network module. The network module transmits a shipping status message to an external device. The use of a smart tracking device or package and package operating, networking, communications, shipping, logistics and transactions platform enables sophisticated and responsive tracking technologies.

### SUMMARY

It is therefore an object of embodiments herein to provide a method and system to address this common problem and make it easy and simple for a user to set up applications and connections of a product to one or more user devices.

Nowadays, printable NB-IoT tracking labels are developing that can be put on, attached or integrated into packages used for delivery of goods or products. Once the tracking label is cut or torn it connects to the cellular wireless communication network. This means that the producer or/and seller can track when said package is being opened.

The principle of embodiment herein is to use this kind of tracking label to trigger provisioning of applications related to a product to the buyer's mobile device or other devices. The tracking label is associated with information on shipping and the buyer's individual mobile device which may be provided by the buyer at the purchase of the product as well as the exact specifications for the shipped product. Once the package is opened by the buyer, the producer and/or seller of the product will be notified and can initiate provisioning of related applications to said buyer so as to simplify the setup procedure of said product on the buyer's mobile device or other devices.

According to an aspect of embodiments herein, the object is achieved by a system and method therein for provisioning and installing a content related to a product. The system comprises a server device associated with a provider of the product, a user device associated with a receiver of the product and an electronic label attached to a package of the product. The content related to the product is provided by the server device to the user device. The electronic label sends to the server device a signal upon breaking of a seal of the electronic label. The server device receives the signal sent from the electronic label. The server device determines a content related to the product based on information associated to the electronic label. The server device sends the determined content to the user device and the user device installs the content related to the product to the user device.

The content may be an application or media related to the product, a brand image of the product or any information related to the product to be used by the receiver of the product or to be installed or loaded to the user device.

According to an aspect of embodiments herein, the object is achieved by a server device and method therein for provisioning a content related to a product to a user device. The server device is associated with a provider of the product. The user device is associated with a receiver of the product and an electronic label is attached to a package of the product. The user device may be a personal communication device e.g., a UE, a mobile phone or any other user devices associated with the receiver of the product in which the content related to the product is to be installed.

The server device receives a signal sent from the electronic label upon breaking of a seal of the electronic label.

The server device determines a content related to the product based on information associated to the electronic label. The server device may determine the content by looking up in a data base comprising contact information of the receiver of the product and information on the user device, product specifications and product related applications, media or information.

The server device sends the determined content to the user device.

According to an aspect of embodiments herein, the object is achieved by a user device and method therein for installing a content related to a product to the user device. The user device is associated with a receiver of the product. An electronic label is attached to a package of the product and the content related to the product is any one of an application related to the product, media related to the product, a brand image of the product or any information related to the product to be used by the receiver of the product or to be installed to the user device.

The user device receives a message from a server device associated with a provider of the product upon breaking of a seal of the electronic label. The message comprises any one or a combination of a question if the receiver of the product needs help for starting up the product, a link to the content related to the product, a request to obtain information on the user device and/or additional information of the receiver of the product, or a requiring if the server device is allowed to fetch or extract information on the user device and additional information of the receiver of the product from a web server or a user account stored in a cloud or a network node in a wireless communication network.

The user device responds the received message based on what kind of message has been received.

The user device installs the content related to the product.

The embodiments herein simplify provisioning of the content e.g., applications to a buyer's mobile device for a purchased consumer device which is about to be connected to said buyer's mobile device. The embodiments herein enable right timing for provisioning of the applications since all related applications will be available for installation on said buyer's mobile device just as the buyer opens the package. There is no need for the buyer to search for what applications to install.

The embodiments herein can address for example a preparation set up and programming phase so that the devices can be up and running as they should from the moment they are unpacked or plugged in.

The embodiments herein also provide assistance that can help connecting and aligning everything in a smart home to work smartly together based on user's needs.

Therefore, the embodiments herein provide an improved system and method for simplifying the procedure for a user to set up of applications and connections of a product to one or more user devices.

### BRIEF DESCRIPTION OF THE DRAWINGS

Examples of embodiments herein are described in more detail with reference to attached drawings in which:

FIG. 1 is a schematic block overview illustrating a system in which methods for provisioning and installation content related to a product to a user device according to embodiments herein may be implemented;

FIG. 2 is a flow chart illustrating a method performed in a system according to embodiments herein;

FIG. 3 is a flow chart illustrating a method performed in a server device according to embodiments herein;

FIG. 4 is a flow chart illustrating a method performed in a user device according to embodiments herein;

FIG. 5 is a block diagram illustrating a server device in which the method for provisioning a content related to the product to a user device according to embodiments herein is implemented; and

FIG. 6 is a block diagram illustrating a user device in which the method for installing or loading a content related to the product according to embodiments herein is implemented.

### DETAILED DESCRIPTION

FIG. 1 shows a schematic block of a system 100 in which methods for provisioning and installation a content related to a product to a user device according to embodiments herein may be implemented.

As shown in FIG. 1, the system 100 comprises a server device 110. The server device 110 is associated with a provider of a product 120, e.g. a producer or seller of the product. The server device 110 may be a computer, a cloud server, a distributed cloud server or the like. The product 120 may be purchased or ordered online by a purchaser, hereafter referred as a receiver of the product, and shipping details e.g., address and mobile phone number of the receiver of the product may be entered during purchasing. The information on the purchase, the product specifications, the related applications and contents are stored in a database in the server device 110. The purchased product 120 is packaged by the provider of the product in a package 130. An electronic label 140, e.g., an NB-IoT label, is put on or attached to or integrated into the package 130 by the provider of the product and the package 130 is delivered to the receiver of the product. The receiver of the product has a user device 150, e.g., a mobile phone, a smartphone or any device such as a tablet, a laptop, a wearable watch etc., which needs to install a content 160 related to the product 120. When the package 130 is received by the receiver of the product and upon the electronic label 140 is cut or torn, the electronic label 140 connects to a wireless communication network and a signal is sent by the electronic label 140 to the server device 110 via the wireless communication network. The wireless communication network is show as a base station 170, which is a network access node and may be eNB. gNB, eNodeB (eNB), gNodeB, etc. The provider of the product is notified that the package has been opened. The provider of the product looks up the related package and purchasing order in the database in the server device 110 and initiates provisioning of the content related to the purchased product to the user device associated with the receiver of the product. The receiver of the product accepts the installation of provisioned content and the content is installed in the user device 150.

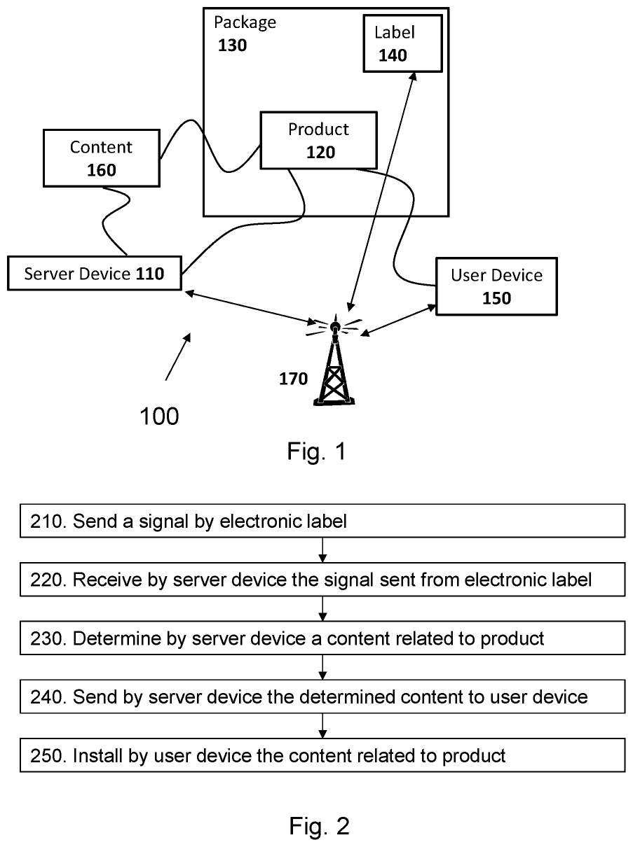

A method performed in the system 100 for provisioning and installation a content related to a product to a user device according to embodiments herein will be described with reference to FIG. 2. The method comprises the following actions.

Action 210

The electronic label 140 sends to the server device 110 a signal upon breaking of a seal of the electronic label (140). The signal may be sent via a wireless communication network to the server device 110. The wireless communication network may be any network with cellular technologies, such as a Universal Mobile Telecommunications System (UMTS) which is a third generation (3G) telecommunication network and evolved from the second generation (2G) Global System for Mobile Communications (GSM), a Fourth Generation (4G) network or Long Term Evolution (LTE) or a Fifth Generation (5G) New Radio (NR) network.

Action 220

The server device 110 receives the signal sent from the electronic label 140.

Action 230

The server device 110 determines a content related to the product based on information associated to the electronic label 140.

Action 240

The server device 110 sends the determined content to the user device 150.

Action 250

The user device 150 installs the content related to the product.

In the following, details of the actions performed in the system for provisioning and installation the content related to the product will be described with respect to the server device 110 and user devices 150.

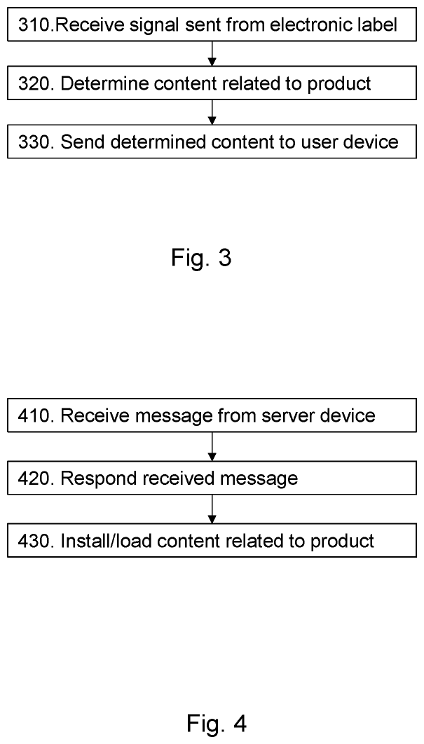

A method performed in the server device 110 for provisioning a content related a product to the user device 150 according to embodiments herein will be described with reference to FIG. 3. The method comprises the following actions.

Action 310

The server device 110 receives a signal sent from the electronic label 140 upon breaking of a seal or similar of the electronic label 140, that is when the label detects that the package is opened. The signal is sent by the electronic label 140 via the wireless communication network to the server device 110. As describe above, the electronic label 140 is attached to a package of the purchased product. The electronic label may be an NB-IoT label or any label with wireless communication capability via any existing wireless communication network.

Action 320

The server device 110 determines a content related to the product based on information associated to the electronic label 140.

The content may be an application to be installed or loaded on the user device 150.

The content may be media related to the product, a brand image of the product or any information related to the product to be used by the receiver of the product or to be installed or loaded to the user device 150. For examples, the brand image and/or media of the product may be shared by the receiver of the product on any social media or added to his/her collection of purchased products, price and purchase date information of the product may be shared to his/her insurance company, Extended Reality (XR) information related to a product that may be used in XR glasses to overlay e.g., new textures on said product when looking at the product using XR glasses, alternatively a ringtone, 3D printing blueprints that may be used to extend said product. The content may also be a 3D model and/or point cloud definition of the product that may be used to help user device(s) learn, e.g. machine learning about how the product looks so as to have it detected and recognized, e.g. with object detection and recognition technique, and thereby found or marked by the user's device(s) such as e.g. an XR headset etc.

The server device 110 may determine the content related to the product by looking up in a database comprising contact information of the receiver of the product, information on the user device 150, product specifications and product related applications, media or any information related to the product.

The contact information may comprise any one or a combination of the following:
a) a destination address, e.g. Internet Protocol (IP) address, of the user device 150;
b) subscriber or telephone number of the user device 150;
c) email address of the receiver of the product.

The information on the user device 150 may comprise the type and operating platform of the user device 150.

The information associated with the electronic lable 140 may be any one of the above listed contact information which enables the server device 110 to contact the receiver of the product. For examples, the subscriber or telephone number of the user device 150 can be used to send a link of application or a message etc. to the user device 150. The IP address of the user device 150 or email address may be used by the server device 110 to send a message or the content to the user device 150 via internet. The type and operating platform of the user device 150 is used to determine the right application for the user device 150.

The contact information of the receiver of the product and information on the user device may be obtained by a data exchange between the provider and receiver of the product during the purchasing of the product. For example, when the receiver of the product orders a product on-line, the contact information on e.g., telephone number and/or email address, shipping address are usually required. This information is stored in the database on the server device 110.

According to some embodiments herein, the server device 110 may obtain additional information of the receiver of the product on any one of the following:
a) other devices that are associated with the receiver of the product and need to use or install the product related content;
b) types of the other devices, operating platforms of the other devices.
c) pairing codes, Postal Index Number (PIN) codes, or digital certificates of the user device 150 and/or other devices.

Any one or a combination of the above listed additional information may be used or useful for different scenarios. For example, if the receiver of the product has an Android mobile phone and a MacBook laptop and both may potentially benefit from getting e.g., a specific manufacturer application for the specific operating platform, e.g., Android, Mac OS, that will improve the control and settings of the product e.g., a headset. Pairing codes used in e.g., Bluetooth pairing may be pre-set on the purchased headsets and bundled with application provisioned to user's mobile device so as to more smoothly and securely pair the two devices automatically. For example, Bluetooth pairing code may be a part of the provisioned application to the user's device which will then have the device and its newly installed e.g. Jabra application quickly and safely connect to the newly bought Jabra headset using a unique pairing or PIN code. It may also be more advanced security solutions than a simple PIN code, such as a digital certificate, etc.

The information on the user device 150 and the additional information of the receiver of the product may be stored in a cloud or a network node in the wireless communication network and managed by a user account e.g., a Google account, of the receiver of the product. The user account usually has all the related information, e.g. password, pairing code, types and operating platforms of the user device or all other devices associated with the receiver of the product. One may use Google credentials during the purchase, or link the purchase to Google account, then Google can share, based on user's approval, device information e.g. mobile device, laptop device, anything the user has logged into Google account, with the provider of the product. A web server can also extract device related information, see e.g. https://www.deviceinfo.me, that shows how the server extracts the information related to devices.

Therefore, according to some embodiments herein, the server device 110 may obtain the information on the user device and the additional information of the receiver of the product by a data exchange between the provider and receiver of the product during the purchasing of the product. For example, when the receiver of the product orders a product on-line, besides the contact information on e.g., telephone number and shipping address, the receiver of the product may be asked to give the provider of the product a permission to fetch or extract the information on the user device and the additional information of the receiver of the product from the web server or the user account stored in the cloud or the network node in the wireless communication network. The server device 110 fetches or extracts these information and then stores thses information in the database on the server device 110.

Another way to share the information about the user devices with the provider of the product is that the user device 150 may receive a request if it is ok to share the user account profile information about user devices and related operating platform e.g., Android version number X, Mac OS version number Y, etc. to the provider of the product when the package of the product is open.

Therefore, according to some embodiments herein, the server device 110 may send a message to the user device 150 to request the information on the user device and additional information of the receiver of the product from the user device 150 and receive these information from the user device 150. The server device 110 may also send a message to request a permission to fetch or extract the information on the user device and the additional information of the receiver of the product from the web server or the user account stored in the cloud or the network node in the wireless communication network. If the permission is given by the user device 150 then the server device 110 fetches and extract these information from the web server or the user account stored in the cloud or the network node in the wireless communication network.

Action 330

The server device 110 sends the determined content to the user device 150. The content may be sent to the user device 150 directly or after a period of time after the electronic label is cut or torn. The time to send the content may be determined based on settings or preferences at the most optimal point in time. The content may be sent in a message comprising a link to the content.

In the following a method performed in the user device 150 associated with a receiver of a product for installing a content related to the product according to embodiments herein will be described with reference to FIG. 4. The product may be purchased or ordered in an online shop. The provider of the product attaches an electronic label 140 to a package of the product for tracking when the package has been delivered to the receiver of the product. The electronic label 140 is also used for triggering or initiating provisioning of the content related to the product to the user device 150. As described above, the content related to the product may be any one of an application related to the product, media related to the product, a brand image of the product or any information related to the product to be used by the receiver of the product or to be installed or loaded to the user device 150. The method comprises the following actions:

Action 410

The user device 150 receives a message from a server device 110 associated with a provider of the product upon breaking of a seal of the electronic label. The message may be any one of:
a) a question if the receiver of the product needs help for starting up the product;
b) a link to the content related to the product;
c) a request to obtain information on the user device 150 and/or additional information of the receiver of the product; or
d) a requiring if the server device 110 is allowed to fetch or extract information on the user device 150 and/or additional information of the receiver of the product from a web server or a user account stored in a cloud or a network node in a wireless communication network.

As described above, the electronic label 140 connects to a wireless communication network upon breaking of a seal of the electronic label 140 and a signal is sent to the server device 110. In this way, the provider of the product is notified once the package is opened by the receiver of the product. The very opening moment of the package is interesting from a sales perspective where the seller can create added value by “making the experience of a new purchased product amazing and enjoying full”.

There are several ways of improving the user experience of a new purchased product depends on different scenaries. For examples, a simple message “Do you need help for getting the device started?” will make the receiver of the product feel good when he/she just opens the package in case the server device 110 has not obtained the information on the user device 150 during purchasing. For simplify the setting up procedure, a link to the content related to the product may be sent to the user device 150 when the receiver of the product opens the package in case the server device 110 has obtained the information on the user device 150 during purchasing. The receiver of the product can just click the link then all the content related to the product is installed or loaded to the user device 150.

If the receiver of the product has other devices need to install or load the content related to the product or connect to the product, the types and operating platforms of the other devices and pairing codes which are part of the additional information listed above may be provided to the server device 110 by responding to the request from the server device 110 or give a permission to the server device 110 to fetch or extract information on the user device 150 and/or additional information of the receiver of the product during purchasing.

Action 420

The user device 150 responses the received message based on what kind of message has been received, e.g. downloading the content by clicking the link, sending the requested information to the server device 110 or giving a permission to the server device 110 to fetch or extract the requested information from the web server or the user account stored in the cloud or the network node in the wireless communication network.

Action 430

The user device 150 installs the content related to the product. For example, when the content is downloaded and ready to install, a prompt may be send to the user device 150, e.g. “Proceed? Yes/No” to protect against mistakes and intentional attacks. The receiver of the product then can accept and install the content to the user device 150.

To summarize, when a product is ordered, the provider of the product packages the product and adds an electronic label 140 and stores the details of the purchase in a database on a server device 110. Once the package is opened by the receiver of the product, the provider of the product will be notified automatically and can initiate provisioning of the content related to the product to said receiver of the product. That is the provisioning of the content related to a product is triggered by the electronic label 140 at the moment when the package is opened.

The embodiments herein can address for example a preparation set up and programming phase so that the devices can be up and running as they should from the moment they are unpacked or plugged in.

The embodiments herein also provide assistance that can help connecting and aligning everything in a smart home to work smartly together based on user's needs. As discussed above, Bluetooth pairing code, PIN code or a digital certificate may be a part of the provisioned content to the user's devices which will then have the devices and the newly bought product quickly, safely and automatically connected to each other.

Advantages of the embodiments herein are that the server device 110 associated with the provider of the product becomes aware that the package of a product is opened just when the electronic label is broken and not the day before when the package being sent or an hour or day after opening. To provide the content related to the product and assistance on setting up the functionality of the product at the very opening moment of the package, the setup procedure of the product on the user's mobile device or other devices is simplified and the user experience of a new purchased product is improved.

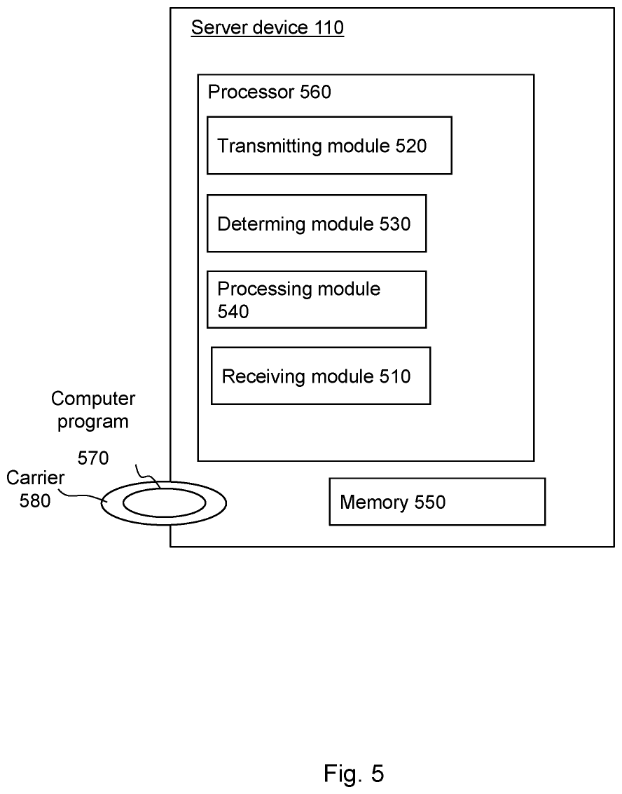

To perform the method actions in the server device 110 for provisioning a content related a product to the user device 150 according to embodiments herein, the server device 110 comprises circuits, modules or units as depicted in FIG. 5. The server device 110 comprises a receiving module 510, a transmitting module 520, a determining module 530, a processing module 540, a memory 550 etc. The server device 110 is configured to perform any one of the method actions 310-330 described above.

The server device 110 is configured to, e.g. by means of the receiving module 510 being configured to, receive a signal sent from the electronic label 140 upon breaking of a seal of the electronic label 140.

The server device 110 is configured to, e.g. by means of the determining module 530 being configured to, determine a content related to the product based on information associated to the electronic label. The information comprises specifications on the product, contact information of the receiver of the product, information on the user device 150.

The server device 110 is configured to, e.g. by means of the transmitting module 520 being configured to, send the determined content to the user device 150.

The server device 110 may be configured to, e.g. by means of the determining module 530 being configured to, look up in a data base comprising the contact information of the receiver of the product, information on the user device product specifications and product related applications, media or information.

Those skilled in the art will appreciate that the receiving module 510, the transmitting module 520, the determining module 530 and the processing module 540 described above in the server device 110 may be referred to one circuit or unit, a combination of analog and digital circuits, one or more processors, e.g. processor 560, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors, such as the processor 560 in the server device 110 together with computer program code for performing the functions and actions of the embodiments herein. The program code mentioned above may also be provided as a computer program product, for instance in the form of a data carrier 580 carrying computer program code 570, as shown in FIG. 5, for performing the embodiments herein when being loaded into the server device 110. One such carrier may be in the form of a CD ROM disc. It is however feasible with other data carriers such as a memory stick. The computer program code may furthermore be provided as pure program code on a cloud and downloaded to the server device 110.

The memory 550 in the server device 110 may comprise one or more memory units and may be arranged to be used to store received information, data, configurations and applications to perform the method herein when being executed in the server device 110.

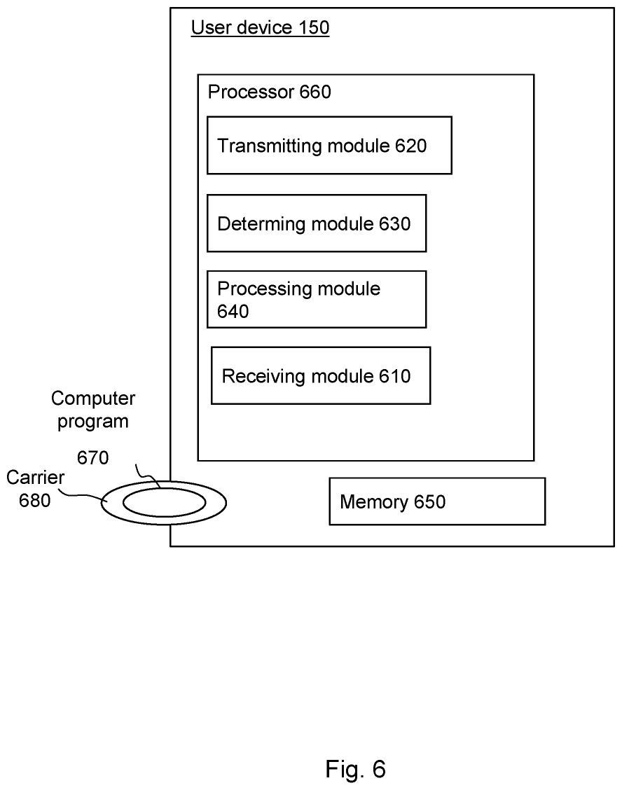

To perform the method actions in the user device 150 for installing a content related to the product according to embodiments herein, the user device 150 comprises circuits, modules or units as depicted in FIG. 6. The user device 150 comprises a receiving module 610, a transmitting module 620, a determining module 630, a processing module 640, a memory 650 etc. The user device 150 is configured to perform any one of the method actions 310-430 described above.

The user device 150 is configured to, e.g. by means of the receiving module 610 being configured to, receive a message from a server device 110 associated with a provider of the product upon breaking of a seal of the electronic label 140.

The user device 150 is configured to, e.g. by means of the determining module 630 being configured to, respond the received message based on what kind of message has been received.

The user device 150 is configured to, e.g. by means of the determining module 630 being configured to, install the content related to the product to the user device 150.

Those skilled in the art will appreciate that the receiving module 610, the transmitting module 620, the determining module 630 and the processing module 630 described above in the user device 150 may be referred to one circuit or unit, a combination of analog and digital circuits, one or more processors, e.g. processor 660, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors, such as the processor 660 in the user device 150 together with computer program code for performing the functions and actions of the embodiments herein. The program code mentioned above may also be provided as a computer program product, for instance in the form of a data carrier 680 carrying computer program code 670, as shown in FIG. 6, for performing the embodiments herein when being loaded into the user device 150. One such carrier may be in the form of a CD ROM disc. It is however feasible with other data carriers such as a memory stick. The computer program code may furthermore be provided as pure program code on a server or a cloud and downloaded to the user device 150.

The memory 650 in the user device 150 may comprise one or more memory units and may be arranged to be used to store received information, data, configurations and applications to perform the method herein when being executed in the user device 150.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A method performed in a system for provisioning and installing a content related to a product, wherein the system comprises a server device associated with a provider of the product, a user device associated with a receiver of the product, an electronic label attached to a package of the product, and wherein the content related to the product is provided by the server device to the user device, the method comprising:
sending, by the electronic label to the server device, a signal upon breaking of a seal of the electronic label;
receiving, by the server device, the signal sent from the electronic label;
determining, by the server device, a content related to the product based on information associated to the electronic label;
sending, by the server device, the determined content to the user device;
installing, by the user device, the content related to the product to the user device.

2. The method according to claim 1, wherein the content is an application or media related to the product, a brand image of the product or any information related to the product to be used by the receiver of the product or to be installed or loaded to the user device.

3. A system for provisioning and installing a content related to a product, wherein the system comprises a server device associated with a provider of the product, a user device associated with a receiver of the product and an electronic label attached to a package of the product, and wherein the content related to the product is provided by the server device to the user device, the system being configured to perform the method according to claim 1.

4. A method performed in a server device associated with a provider of a product for provisioning a content related to the product to a user device, wherein an electronic label is attached to a package of the product, the method comprising:
receiving a signal sent from the electronic label upon breaking of a seal of the electronic label;
determining a content related to the product based on information associated to the electronic label; and
sending the determined content to the user device.

5. The method according to claim 4, wherein the content is an application or media related to the product, a brand image of the product or any information related to the product to be used by the receiver of the product or to be installed or loaded to the user device.

6. The method according to claim 4, wherein determining a content related to the product based on the information associated to the electronic label comprises looking up in a data base comprising contact information of the receiver of the product, information on the user device, product specifications and product related applications, media or information.

7. The method according to claim 4, wherein the contact information of the receiver of the product comprises any one of the following:
a) Internet Protocol, IP, address of the user device;
b) subscriber or telephone number of the user device;
c) email address of the receiver of the product; and
the information on the user device comprises the type and operating platform of the user device.

8. The method according to claim 6, wherein the contact information of the receiver of the product and information on the user device is obtained by a data exchange between the provider and receiver of the product during the purchasing of the product.

9. The method according to claim 4, further comprising obtaining additional information of the receiver of the product on any one of the following:
a) other devices that are associated with the receiver of the product and need to use or install the product related content;
b) IP address of the other devices;
c) types and operating platforms of the other devices;
d) pairing codes, Postal Index Number, PIN codes, or digital certificates of the user device and/or other devices for device-to-device connection.

10. The method according to claim 4, further comprising sending a message to the user device to request the information on the user device and additional information of the receiver of the product from the user device or to request a permission to fetch or extract the information on the user device and the additional information of the receiver of the product from a web server or a user account stored in a cloud or a network node in a wireless communication network.

11. The method according to claim 4, wherein the information on the user device and the additional information of the receiver of the product are obtained by fetching or extracting the information on the user device and the additional information of the receiver of the product from a web server or a user account stored in a cloud or a network node in a wireless communication under a permission given by the receiver of the product by a data exchange between the provider and receiver of the product during the purchasing of the product.

12. A server device associated with a provider of a product for provisioning a content related to the product to a user device, wherein an electronic label is attached to a package of the product, the server device being configured to perform the method according to claim 4.

13. A method performed in a user device associated with a receiver of a product for installing a content related to the product, wherein an electronic label is attached to a package of the product and the content related to the product is any one of an application related to the product, media related to the product, a brand image of the product or any information related to the product to be used by the receiver of the product or to be installed or loaded to the user device, the method comprising:
receiving a message from a server device associated with a provider of the product upon breaking of a seal of the electronic label, wherein the message comprises any one or a combination of:
a) a question if the receiver of the product needs help for starting up the product,
b) a link to the content related to the product,
c) a request to obtain information on the user device and/or additional information of the receiver of the product, or
d) a requiring if the server device is allowed to fetch or extract information on the user device and/or additional information of the receiver of the product from a web server or a user account stored in a cloud or a network node in a wireless communication network;
responding the received message based on what kind of message has been received;
installing the content related to the product to the user device.

14. The method according to claim 13, wherein responding the received message based on what kind of message has been received comprises:
downloading the content from the link; or
sending the information on the user device and additional information of the receiver of the product to the server device; or
giving permission to the server device to fetch or extract the information on the user device and additional information of the receiver of the product from a web server or a user account stored in a cloud or a network node in the wireless communication network.

15. The method according to claim 13, wherein the information on the user device comprises the type and operating platform of the user device and the additional information of receiver of the product comprises any one or a combination of the following:
a) other devices that are associated with the receiver of the product and need to use or install the product related content;
b) types and operating platforms of the other devices;
c) pairing codes of the user device and/or other devices.

16. A user device associated with a receiver of a product for installing a content related to the product, the user device being configured to perform the method according to claim 13.

17. The method according to claim 1, wherein the electronic label is a Narrow Band Internet of Things, NB-IoT label, or any label with wireless communication capability via any existing wireless communication network.
